(19) United States
(12) Patent Application Publication
(10) Pub. No.: US 2004/0104250 A1
(43) Pub. Date: Jun. 3, 2004

(54) Packaging and dispenser device including a flow reducer

(75) Inventor: Guilhem Rousselet, Paris (FR)

Correspondence Address: LERNER, DAVID, LITTENBERG,, KRUMHOLZ & MENTLIK, 600 SOUTH AVENUE WEST, WESTFIELD, NJ, 07090, US

(73) Assignee: L'OREAL, Paris (FR)

(21) Appl. No.: 10/681,950

(22) Filed: Oct. 9, 2003

Related U.S. Application Data
(60) Provisional application No. 60/447,009, filed on Feb. 13, 2003.

(30) Foreign Application Priority Data
Oct. 10, 2002 (FR) 02 12587

(51) Int. Cl. B67D 1/00

(52) U.S. Cl. 222/196.1

(57) ABSTRACT

A packaging and dispenser device is disclosed. The device comprises a receptacle, at least one ball disposed inside the receptacle, a flow reducer including a passage for the substance, and an orifice through which the passage opens out inside the receptacle.

### CROSS REFERENCE TO RELATED APPLICATIONS

The present application claims priority of French Application No. 02 12587 filed Oct. 10, 2002 and U.S. Provisional Application No. 60/477,009 filed Feb. 13, 2003, the teachings of which are incorporated herein by reference.

### FIELD OF THE INVENTION

The present invention relates to a device for packaging and dispensing a substance, in particular a cosmetic or personal care product.

### BACKGROUND OF THE INVENTION

Receptacles for dispensing cosmetics or personal care products that currently exist include a neck into which a flow reducer is inserted. The flow reducer in these devices is typically provided with a passage having a section that is selected as a function of the desired output rate for the substance, and the passage opens out into the receptacle via an orifice including a circular edge that is entirely contained in the same plane.

When the substance contained in the receptacle needs to be homogenized before being used, as is the case for substances comprising two phases, for example, and in particular, foundations or make-up removers, it is recommended to insert one or two balls into the receptacle. By shaking the receptacle, the balls are moved, enabling one of the phases to be dispersed into the other.

Each ball has a diameter that is greater than that of the orifice of the flow reducer so that it is unable to engage in the reducer, but it can nevertheless come to bear on the end edge of said reducer when the receptacle is used upside down, thereby hindering the flow of the substance.

To prevent a ball from completely blocking the passage when the receptacle is upside down, it is known to provide the flow-reducer orifice with crenellations. Thus, when a ball comes to bear on the flow reducer, the substance can still flow through the crenellations. However, in this case, the rate at which the substance is dispensed is significantly reduced, and the substance flows out with turbulence, which can lead the user to think that the device is not functioning correctly.

In addition, the dimensions of the ball and the dimensions of the orifice can be made similar by putting a reducer on the orifice, such that the ball, under the effect of the pressure of the substance, is capable of becoming jammed in the flow orifice. Finally, putting such a reducer in place on the receptacle can cause difficulties since the reducer can accidentally catch on the neck of the receptacle as a result of the presence of the crenellations.

### SUMMARY OF THE INVENTION

There exists a need for devices including a flow reducer and one or more balls that enable a substance to be dispensed in satisfactory manner, while being reliable, inexpensive, and relatively easy to make.

In accordance with one or more embodiments of the present invention, a device is provided for dispensing a substance comprising a receptacle, at least one ball disposed inside the receptacle, and a flow reducer including a passage for the substance, which passage opens out inside the receptacle via an orifice. The reducer is arranged in a manner that does not provide any stable central bearing position for the ball in the vicinity of the orifice.

The term “stable position” is used to designate a position of the ball in contact with the reducer, in which the ball, when subjected to a single small displacement from said position, tends to return spontaneously back into said position under the effect of gravity. The receptacle is positioned upside down with the axis of the reducer being inclined relative to the vertical by any angle of less than 30°, e.g. less than 20°.

The term “central bearing position” is used to designate a position in which the axis of the reducer intersects the ball. A central bearing position corresponds, for example, to the case in which a vertical line coinciding with the axis of the reducer passes through the center of gravity of the ball.

A stable central bearing position corresponds, for example, to the position that the ball would occupy if it was bearing against a circle having a diameter at least two thirds of its maximum diameter on the edge of a circular orifice situated at one end of a conventional reducer. The edge extends entirely in a plane perpendicular to the axis of the reducer, and possibly being interrupted by crenellations.

In one or more embodiments of the present invention, when the ball comes to bear on the orifice and occupies a central region above said orifice, while the receptacle is upside down, the ball moves away spontaneously under gravity, thereby freeing the orifice, and preventing the flow of the substance in the passage from being hindered. This can prevent any need for crenellations on the edge of the orifice and can thus reduce the risk of the ball jamming in the reducer. According to one or more embodiments of the invention a device is provided that enables flow to be provided that is not greatly disrupted, and the reducer to be made easily by molding plastics material.

In one embodiment of the invention, the edge of the orifice has at least one portion, in particular, at least two opposite portions, that are convex towards the inside of the receptacle. The edge of the orifice can be configured in such a manner that it does not itself provide more than two bearing points at a time for the ball. In one embodiment of the invention, the edge of the orifice does not have a portion contained in a single plane. In certain embodiments, the flow reducer can be configured in such a manner that the ball can contact it at a maximum of three points.

In one embodiment of the invention, at least one portion of the edge of the orifice is defined by the intersection of a tubular wall of the reducer with a cylindrical surface. The cylindrical surface may extend along an axis perpendicular to the axis of the tubular wall, and have a director line which includes a portion of a circle, an ellipse, or a triangle.

In another embodiment of the invention, at least one portion of the edge of the orifice is defined by the intersection of a tubular wall of the reducer with an ellipsoid, in particular a sphere, or with a paraboloid that is convex towards the inside of the receptacle, and more generally any surface, in particular a quadric, that is generally with convex towards the inside of the receptacle, possibly including facets.

In one embodiment of the invention, the tubular wall has an end edge having at least one plane portion at its periphery. Such a plane portion can facilitate manufacture and unmolding. The flow reducer can have a shape that is symmetrical about its axis, thereby making it easier to manufacture by molding plastics material.

In one embodiment of the invention, the receptacle has a neck into which the flow reducer is inserted at least in part, the reducer being configured so as to be retained by friction in the neck. The passage in the reducer can extend along a longitudinal axis parallel to the axis of the neck. The reducer can be made in a single piece of plastics material, in particular of polyolefin. In one embodiment of the invention, the receptacle contains a cosmetic, in particular a substance comprising at least two phases. The receptacle may have resiliently deformable walls, the receptacle being capable of dispensing substance in response to a reduction in its inside volume when pressure is exerted on its walls.

In another embodiment of the invention, a packaging and dispenser device is provided that comprises a receptacle, at least one ball disposed inside the receptacle, and a flow reducer including a passage for the substance, which passage opens out inside the receptacle via an orifice having an edge that is arranged in such a manner that the ball cannot come to bear thereon at more than two points at a time.

### BRIEF DESCRIPTION OF THE DRAWING

The invention will be better understood on reading the following detailed description of non-limiting embodiments thereof, and on examining the accompanying drawing, in which:

FIG. 1 is a side, elevational, sectional view of a device of the present invention;

FIG. 2 is a side, elevational, sectional fragmentary view of the flow reducer of the device shown in FIG. 1;

FIG. 3 is a side, elevational, sectional fragmentary view of the flow reducer shown in FIG. 2;

FIG. 4 is a bottom, elevational fragmentary view taken along arrow IV of the flow reducer shown in FIG. 3; and

FIG. 5 is a side, elevational and fragmentary view of another embodiment of a flow reducer used in the device of the present invention; and

FIG. 6 is a side, elevational, fragmentary view of another embodiment of a flow reducer used in the device of the invention.

### DETAILED DESCRIPTION

Before describing several exemplary embodiments of the invention, it is to be understood that the invention is not limited to the details of construction or process steps set forth in the following description. The invention is capable of other embodiments and of being practiced or carried out in various ways.

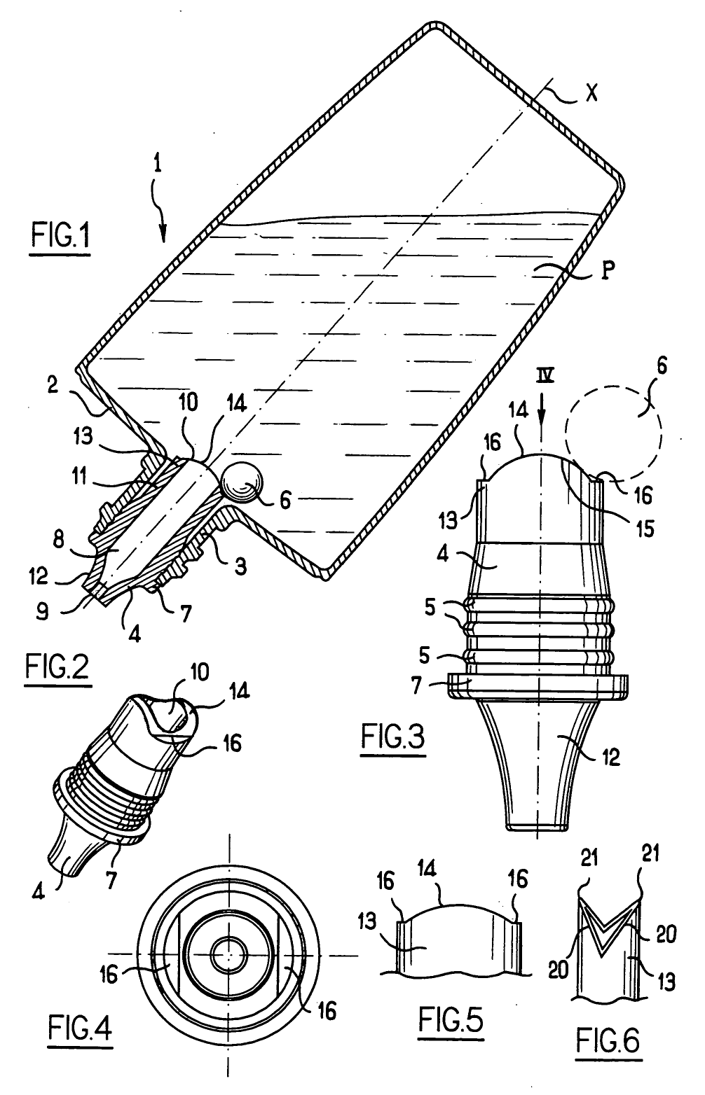

FIG. 1 shows an exemplary embodiment of a packaging and dispenser device 1 of the invention, said device comprising a receptacle 2 having a neck 3 of axis X into which a flow reducer 4 is inserted. In the embodiment shown in FIG. 1, the neck 3 has an inside diameter lying in the range of about 7 millimeters (mm) to about 11 mm, for example. It will be understood that the invention is not limited to a neck having any particular inside diameter.

The receptacle 2 houses at least one ball 6 inserted therein before the reducer 4 is put in place, and enabling the substance P contained in the receptacle 2 to be homogenized when the receptacle 2 is shaken. By way of example, the substance P can comprise two phases that are to be mixed together before dispensing, or solid particles that are to be dispersed. The body of the receptacle 2 can have resiliently deformable walls that are capable of returning to their initial shape when the user stops pressing on them. The receptacle 2 can be made of plastic material, for example, but it is not beyond the scope of the present invention for the receptacle to be made of other materials, for example, glass or ceramic.

In the example under consideration, the flow reducer 4 does not have any inner fins and includes a tubular wall 11 defining a passage 8 having an axis that coincides with the axis X of the receptacle, said passage opening out outside said receptacle via a dispensing orifice 9 and inside the receptacle 2 via an inlet orifice 10. Annular flanges 5 are provided on the tubular wall 11 so as to retain the reducer 4 by friction in the neck 3, as can be seen in FIG. 3. The reducer 4 bears against the end edge of the neck 3 via a collar 7.

The tubular wall 11 has an external portion 12 emerging from the neck 3 and converging towards the outlet orifice 9, and inside the neck 3 and towards the inlet orifice 10, it has a circularly cylindrical portion 13 of axis X. The edge 14 of the orifice 10 is defined by the intersection of said cylindrical portion 13 with a cylindrical surface 15 having a director line including a portion of a circle, as shown in FIG. 3, and having a generator line perpendicular to the axis X, the edge 14 appearing convex towards to inside of the receptacle 2 in said figure.

It can be seen in FIG. 4 that the wall 11 includes, on either side of the orifice 10, two opposite flats 16 extending perpendicularly to the axis X. In the example under consideration, the ball is spherical, being made of metal for example. Its diameter is greater than the inside diameter of the cylindrical portion 13.

As a result of its shape, the edge 14 of the orifice 10 does not itself provide a stable central bearing position for the ball, since the ball is unstable when bearing against the top of the edge 14. In the example under consideration, it should be observed that the ball 6 contacts the edge 14 at only two points.

In order to dispense the substance after shaking the receptacle 2, the user turns the receptacle upside down and possibly squeezes on its walls so as to reduce its inside volume. Since the reducer is itself arranged in such a manner as to provide no stable central bearing position for the ball, the ball 6 does not remain bearing on the reducer 4 in a central portion where it would block the inlet orifice 10, and the substance can flow out in satisfactory manner. In particular, when the axis of said reducer is substantially vertical, the ball 6 rolls downwards in contact with the end of the reducer.

It is not beyond the scope of the present invention for the edge 14 of the orifice to have a different shape, being defined, for example, by the intersection of the cylindrical portion 13 with a cylindrical surface having a non-circular director line and having a generator line that is optionally perpendicular to the axis X, e.g. having an elliptical director line as shown in FIG. 5, or a triangular director line as shown in FIG. 6. In this case, the reducer can have two facing beveled regions 20, for example, the ball being unable to remain bearing in stable manner on the tops 21 of said beveled regions 20.

Naturally, the invention is not limited to the above-mentioned examples. In particular, the edge of the inlet orifice can also be defined by the intersection of the cylindrical portion 13 with a surface that is generally convex towards the inside of the receptacle, e.g. an ellipsoid, in particular a sphere.

Throughout the description, including in the claims, the term “comprising a” should be understood as being synonymous with “comprising at least one”, unless specified to the contrary.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims and their equivalents.

What is claimed is:

1. A packaging and dispenser device for a substance comprising:
a receptacle;
at least one ball disposed inside said receptacle; and
a flow reducer associated with said receptacle including a passage extending through said flow reducer for the substance, said passage including an inlet orifice in communication with said receptacle, wherein said inlet orifice of said reducer is configured in a manner that does not provide any stable central bearing position for said ball in the vicinity of said inlet orifice.

2. A device according to claim 1, wherein said inlet orifice comprises an edge including at least one portion that is convex towards the inside of said receptacle.

3. A device according to claim 2, wherein said edge of said inlet orifice comprises at least two opposite portions that are convex towards the inside of said receptacle.

4. A device according to claim 1, wherein said edge of said inlet orifice is configured in a manner that does not provide more than two bearing points at a time for said ball.

5. A device according to claim 1, wherein said inlet orifice comprises an edge which does not have a portion contained in a single plane.

6. A device according to claim 1, wherein said inlet orifice comprises an edge including at least one portion defined by the intersection of a tubular wall with a cylindrical surface.

7. A device according to claim 6, wherein said tubular wall includes a longitudinal axis and said cylindrical surface extends along an axis perpendicular to said longitudinal.

8. A device according to claim 6, wherein said cylindrical surface is defined by a director line including a portion of a shape selected for the group consisting of a circle, an ellipse, and a triangle.

9. A device according to claim 1, wherein said inlet orifice embodies an edge including at least one portion defined by the intersection of a tubular wall with an ellipsoid.

10. A device according to claim 6, wherein said tubular wall includes an end edge having at least one plane portion at its periphery.

11. A device according to claim 1, wherein said flow reducer does not have crenellations.

12. A device according to claim 1, wherein said outlet of said receptacle includes a neck into which said flow reducer is inserted at least in part, and wherein said flow reducer is configured so as to be retained by friction in said neck.

13. A device according to claim 1, wherein said the flow reducer comprises a single piece of plastics material.

14. A device according to claim 1, wherein said substance comprises a cosmetic.

15. A device according to claim 9, wherein said ellipsoid comprises a sphere.

16. A device according to claim 13, wherein said plastics material comprises a polyolefin.

17. A device according to claim 1, wherein said substance comprises at least two phases.

18. A flow reducer device comprising:
a first end including an inlet orifice, a second end including an outlet orifice, and a passage between said inlet orifice and said outlet orifice, said first end adapted to cooperate with a ball to reduce flow through said passage, said inlet orifice of said reducer configured in a manner that does not provide any stable central bearing position for said ball in the vicinity of said inlet orifice.

19. A device according to claim 18, wherein said inlet orifice comprises an edge including at least one portion that is convex.

20. A device according to claim 18, wherein said edge of said inlet orifice comprises at least two opposite portions that are convex.

21. A device according to claim 18, wherein said edge of said inlet orifice is configured in a manner that does not provide more than two bearing points at a time for said ball.

22. A device according to claim 18, wherein said flow reducer does not have crenellations.
